(19) United States
(12) Patent Application Publication
(10) Pub. No.: US 2026/0237721 A1
(43) Pub. Date: Aug. 13, 2026

(54) METHOD FOR MANUFACTURING ENERGY STORAGE DEVICE

(71) Applicant: Prime Planet Energy & Solutions, Inc., Tokyo (JP)

(72) Inventors: Takayuki SADAKANE, Kobe-shi (JP); Yuma KAMIYAMA, Osaka-shi (JP)

(21) Appl. No.: 19/534,759

(22) Filed: Feb. 10, 2026

(30) Foreign Application Priority Data
Feb. 12, 2025 (JP) 2025-020700

(51) Int. Cl. H01M 10/04; H01M 4/04; H01M 10/0587; H01M 50/103

(52) U.S. Cl. CPC H01M 10/0481; H01M 4/0445; H01M 10/0587; H01M 50/103

(57) ABSTRACT

Provided is a technology that suppresses air bubbles remaining in an electrode assembly during charging. The manufacturing method disclosed here is a method for manufacturing an energy storage device including an electrode assembly, a nonaqueous electrolyte, and a case accommodating the electrode assembly and the nonaqueous electrolyte. The manufacturing method includes preparing an assembly in which an electrode assembly and a nonaqueous electrolyte are accommodated in a case, applying a pressure P1 to the assembly, applying a pressure P2 lower than the pressure P1 to the assembly after the application of the pressure P1, and charging the assembly while applying the pressure P2 to the assembly.

### CROSS REFERENCE TO RELATED APPLICATION

The present application claims the priority based on Japanese Patent Application No. 2025-020700 filed on Feb. 12, 2025, the entire contents of which are incorporated in the present specification by reference.

### BACKGROUND OF THE DISCLOSURE

### 1. Field

The present disclosure relates to a method for manufacturing an energy storage device.

### 2. Background

Japanese Patent Application Publication No. 2020-149802 discloses a method for manufacturing a nonaqueous electrolyte secondary battery in which a wound electrode assembly and a nonaqueous electrolyte are accommodated in a battery case. This manufacturing method includes an assembly-constructing step, a restraining step, an initial charging step, and an aging step. The assembly-constructing step constructs a battery assembly that includes a battery case accommodating a wound electrode assembly and a nonaqueous electrolyte containing LiBOB and an excess electrolyte between the wound electrode assembly and the battery case. The restraining step restrains the battery assembly by a predetermined pressure. The initial charging step initially charges the battery assembly. The aging step maintains the initially charged battery for a predetermined time. This manufacturing method is characterized in that the restraining pressure to the battery assembly is loosened after the initial charging step and a pumping step of applying a restraining pressure again is then carried out. It is described in the patent publication that in the manufacturing method of such a configuration, the excess electrolyte outside the wound electrode assembly and the retained electrolyte inside the wound electrode assembly can be mixed by carrying out the pumping step, and LiBOB remaining in the excess electrolyte can be decomposed in the aging step, and thereby an increase in the battery resistance after the accomplishment of the manufacturing process can be suppressed.

### SUMMARY

In a process of manufacturing an energy storage device, an assembly is prepared by accommodating an electrode assembly in a case and then injecting an electrolyte in some cases. During the injection of an electrolyte in the preparation of an assembly, air bubbles may enter inside the electrode assembly. If charging is subsequently performed with air bubbles remaining in the electrode assembly, undesirably, for example, uneven charging is caused in the electrode assembly. Accordingly, the present inventor seeks to suppress the air bubbles remaining in the electrode assembly during charging.

The manufacturing method disclosed herein is a method for manufacturing an energy storage device including an electrode assembly, a nonaqueous electrolyte, and a case accommodating the electrode assembly and the nonaqueous electrolyte. The manufacturing method includes preparing an assembly in which an electrode assembly and nonaqueous electrolyte are accommodated in a case; applying a pressure P1 to the assembly; after the application of the pressure P1, applying a pressure P2 lower than the pressure P1 to the assembly; and charging the assembly while applying the pressure P2 to the assembly. Such a configuration can suppress air bubbles from remaining in the electrode assembly during charging.

### BRIEF DESCRIPTION OF THE DRAWINGS

FIG. 1 is a schematic perspective view of an energy storage device 1;

FIG. 2 is a cross-sectional view taken along line II-II of FIG. 1;

FIG. 3 is a schematic perspective view of a sealing plate 14 and an electrode assembly 20;

FIG. 4 is a schematic perspective view of a second current-collecting member 52 and an electrode assembly 20;

FIG. 5 is a schematic view of an electrode assembly 20;

FIG. 6 is a flow diagram of a manufacturing method;

FIG. 7 is a schematic view explaining application of a pressure to a case 10;

FIG. 8 is a schematic view explaining application of a pressure to a case 10;

FIG. 9 is a graph showing changes in the pressure that is applied to a test cell over time in Example; and

FIG. 10 is a graph showing changes in the pressure that is applied to a test cell over time in Comparative Example.

### DESCRIPTION OF THE EMBODIMENTS

An embodiment of an energy storage device disclosed here will be described below. Embodiments described here do not particularly limit the technology described here. The technology disclosed here is not limited to embodiments described here unless otherwise stated. The drawings are schematic and do not necessarily reflect the actual products. Members and parts that perform the same functions are appropriately given the same reference numerals, and duplicate explanation may be omitted. The notation “A to B” indicating a numerical range means “A or more and B or less” unless otherwise specified and also encompasses the meaning “greater than A and less than B”.

In the present specification, the “energy storage device” is a device that causes charge and discharge by moving of a charge carrier between a pair of electrodes (positive electrode and negative electrode) through an electrolyte. Examples of the energy storage device include a secondary battery such as a lithium ion secondary battery; and a capacitor such as a lithium ion capacitor and an electric double layer capacitor. Hereinafter, embodiments of energy storage devices that are lithium ion secondary batteries will be described.

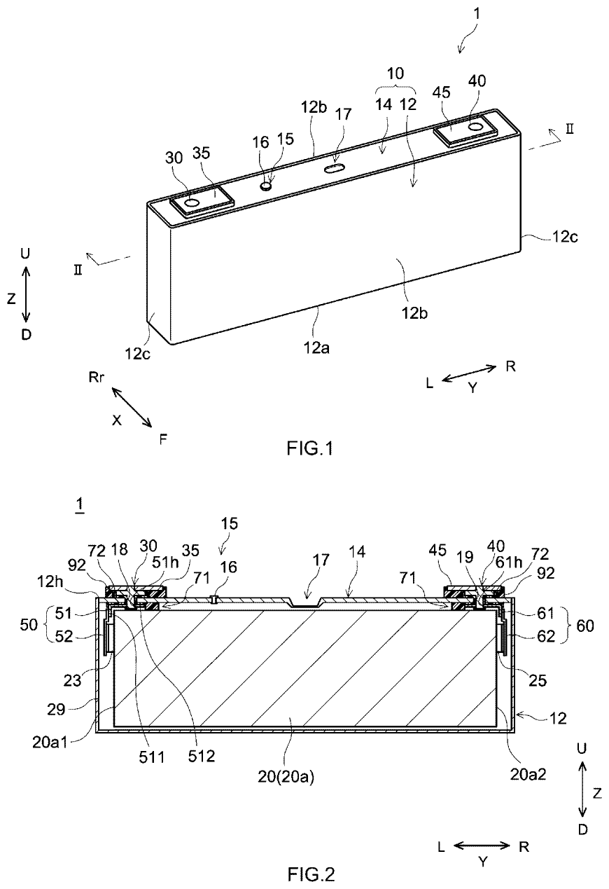

Energy storage devices that are manufacturing objects of the method for manufacturing an energy storage device described here (hereinafter, also simply referred to as “manufacturing method”) will now be described with reference to drawings. FIG. 1 is a schematic perspective view of an energy storage device 1. FIG. 2 is a cross-sectional view taken along line II-II of FIG. 1. As shown in FIGS. 1 and 2, the energy storage device 1 includes a case 10, an electrode assembly 20, a positive electrode terminal 30, a negative electrode terminal 40, external conductive members 35, 45, a positive electrode current collector 50, a negative electrode current collector 60, various insulating members, and a nonaqueous electrolyte (not shown).

The case 10 is an exterior container accommodating the electrode assembly 20 and the nonaqueous electrolyte. The case 10 herein is a flat square case. The material constituting the case 10 is not particularly limited, and, for example, materials that constitute the cases for this type of energy storage devices can be appropriately used.

As shown in FIGS. 1 and 2, the case 10 includes an exterior body 12 and a sealing plate 14. The exterior body 12 includes a bottom wall 12a, a pair of opposing first side walls 12b, and a pair of opposing second side walls 12c. The bottom wall 12a has a rectangular shape. As shown in FIG. 2, the portion opposing the bottom wall 12a is an opening 12h. The pair of opposing first side walls 12b has a rectangular shape and extends from a pair of opposing long sides of the bottom wall 12a. The pair of opposing second side walls 12c has a rectangular shape and extends from a pair of opposing short sides of the bottom wall 12a. In this embodiment, the area of the pair of opposing first side walls 12b is larger than the area of the pair of opposing second side walls 12c.

As shown in FIGS. 1 and 2, the sealing plate 14 has a rectangular plate shape and has a shape corresponding to the opening 12h. The sealing plate 14 here includes an injection hole 15, a safety valve 17, and terminal mounting holes 18, 19. The injection hole 15 is a part for injecting a nonaqueous electrolyte into the case 10. As shown in FIGS. 1 and 2, the injection hole 15 is sealed by a sealing member 16. The safety valve 17 is, for example, a thin wall part that is set such that the internal pressure of the case 10 is released when the internal pressure is increased to a predetermined level or more. The terminal mounting holes 18, 19 are through holes to which the positive electrode terminal 30 or the negative electrode terminal 40 is attached. The sealing plate 14 seals the opening 12h and is welded (for example, laser welded) to the exterior body 12.

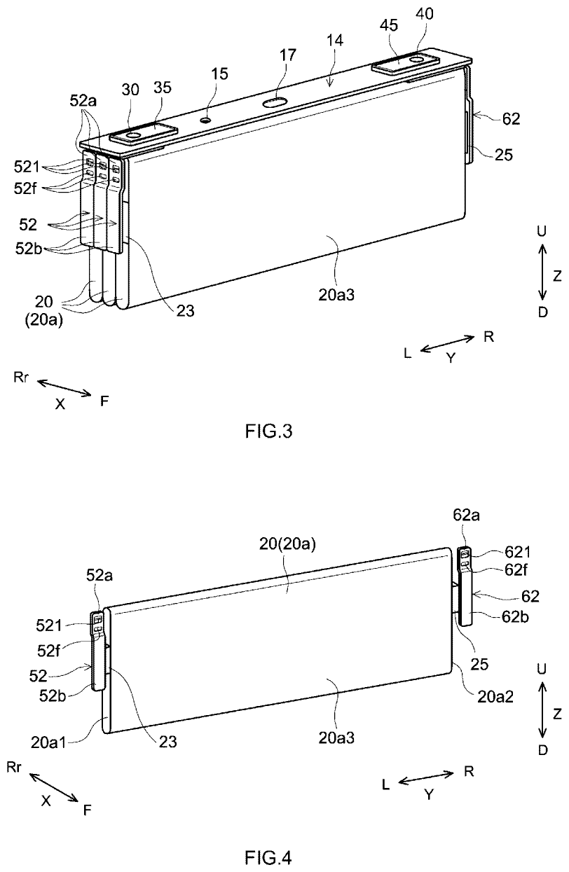

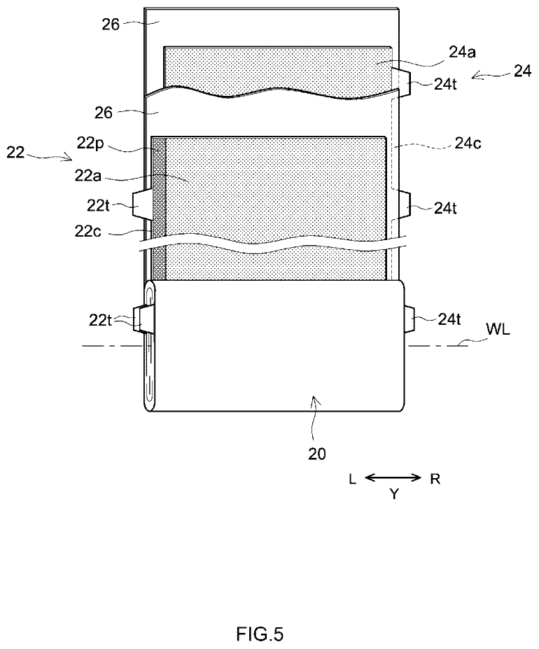

FIG. 3 is a schematic perspective view of the sealing plate 14 and the electrode assembly 20. FIG. 3 schematically illustrates the electrode assemble 20 with the sealing plate 14 attached. FIG. 4 is a schematic perspective view of a second current-collecting member 52 and the electrode assembly 20. FIG. 4 schematically illustrates the electrode assembly 20 with the second current-collecting member 52 attached. As shown in FIG. 3, the energy storage device 1 includes three electrode assemblies 20. As shown in FIGS. 3 and 4, the second current-collecting member 52 of the positive electrode current collector 50 is attached to the electrode assembly 20 on one side in the longitudinal direction Y (the left side in FIGS. 3 and 4), and the second current-collecting member 62 of the negative electrode current collector 60 is attached on the other side in the longitudinal direction Y (the right side in FIGS. 3 and 4). As shown in FIG. 2, the electrode assembly 20 is covered with an electrode assembly holder 29 made of a resin sheet, such as polypropylene (PP), and is arranged inside the exterior body 12. The number of the electrode assemblies 20 possessed by the energy storage device 1 is not particularly limited and may be, for example, 1, 2, or 4 or more.

FIG. 5 is a schematic view of the electrode assembly 20. As shown in FIG. 5, the electrode assembly 20 includes a positive electrode 22, a negative electrode 24, and a separator 26. The electrode assembly 20 is a flat wound electrode assembly in which a long sheet-like positive electrode 22 and a long sheet-like negative electrode 24 are stacked with a long sheet-like separator 26 therebetween and are wound in the sheet longitudinal direction. As shown in FIGS. 2 to 4, the electrode assembly 20 includes a body 20a, a positive electrode tab group 23, and a negative electrode tab group 25. The body 20a is a portion where the positive electrode 22, the negative electrode 24, and the separator 26 are stacked and has, for example, a flat shape.

The width of the body 20 a is not particularly limited, but may be 10 cm or more, 20 cm or more, or 30 cm or more. The width of the body 20a may be 50 cm or less or 40 cm or less. In the present specification, the “width of the body 20a” refers to the length of the body 20a in a direction along the winding axis WL of the electrode assembly 20.

As shown in FIGS. 1, 2, and 5, the electrode assembly 20 is arranged inside the exterior body 12 such that the winding axis WL is parallel to the width direction Y. In this embodiment, the electrode assembly 20 is arranged inside the exterior body 12 such that the winding axis WL is parallel to the bottom wall 12a and orthogonal to the second side wall 12c. Both end faces of the electrode assembly 20 in a direction along the winding axis WL oppose the second side wall 12c of the exterior body 12. In this embodiment, both end faces of the electrode assembly 20 in a direction along the winding axis WL are open faces opening to the outside of the electrode assembly 20. In this embodiment, for convenience of explanation, the end face of the electrode assembly 20 (body 20a) opposing the second side wall 12c on the side (the left side in the width direction Y in FIGS. 2 and 4) adjacent to the positive electrode current collector 50 is referred to as “first open face 20a1”. The end face of the electrode assembly 20 (body 20a) opposing the second side wall 12c on the side (the right side in the width direction Y in FIGS. 2 and 4) adjacent to the negative electrode current collector 60 is referred to as “second open face 20a2”.

As shown in FIGS. 3 and 4, the electrode assembly 20 has a rectangular surface 20a3. The rectangular surface 20a3 is an end face in the stacking direction of the positive electrode 22 and the negative electrode 24 (see FIGS. 4 and 5). In this embodiment, the rectangular surface 20a3 opposes the first side wall 12b of the case 10 (see FIG. 1).

The positive electrode 22 includes a long strip-like positive electrode current collector foil 22c (e.g., aluminum foil) and a positive electrode active material layer 22a fixed to at least one surface of the positive electrode current collector foil 22c. It is not particularly limited, but one side edge of the positive electrode 22 in the width direction Y may be provided with a protective layer 22p as needed. As the materials that constitute the positive electrode active material layer 22a and the protective layer 22p, materials that are used in this type of energy storage devices can be used without particular limitation.

One end of the positive electrode current collector foil 22c in the width direction Y (the left end in FIG. 5) is provided with positive electrode tabs 22t. The positive electrode tabs 22t each protrude towards one side in the width direction Y (the left side in FIG. 5). The positive electrode tabs 22t are provided along the longitudinal direction of the positive electrode 22 with intervals (intermittently). The positive electrode tab 22t is a part of the positive electrode current collector foil 22c and is an exposed part of the current collector foil where neither the positive electrode active material layer 22a of the positive electrode current collector foil 22c nor the protective layer 22p is formed. In this embodiment, the positive electrode tabs 22t protrude in the width direction Y than the separator 26 does. The positive electrode tabs 22t are stacked at one end in the width direction Y (the left end in FIG. 5) and constitute the positive electrode tab group 23 (see FIGS. 2 to 4).

The negative electrode 24 includes a long strip-like negative electrode current collector foil 24c (e.g., copper foil) and a negative electrode active material layer 24a fixed to at least one surface of the negative electrode current collector foil 24c. As the material that constitutes the negative electrode active material layer 24a, materials that are used in this type of energy storage devices can be used without particular limitation.

One end of the negative electrode current collector foil 24c in the width direction Y (the right end in FIG. 5) is provided with negative electrode tabs 24t. The negative electrode tabs 24t each protrude towards one side in the width direction Y (the right side in FIG. 5). The negative electrode tabs 24t are provided along the longitudinal direction of the negative electrode 24 with intervals (intermittently). The negative electrode tab 24t here is a part of the negative electrode current collector foil 24c and is an exposed part of the current collector foil where the negative electrode active material layer 24a of the negative electrode current collector foil 24c is not formed. In this embodiment, the negative electrode tabs 24t protrude in the width direction Y than the separator 26 does. The negative electrode tabs 24t are stacked at one end in the width direction Y (the right end in FIG. 5) and constitute the negative electrode tab group 25 (see FIGS. 2 to 4).

The separator 26 insulates between the positive electrode active material layer 22a of the positive electrode 22 and the negative electrode active material layer 24a of the negative electrode 24. The separator 26 constitutes the outer surface of the electrode assembly 20. As the separator 26, for example, a porous resin sheet made of a polyolefine resin, such as polyethylene (PE) and polypropylene (PP), is used.

As shown in FIGS. 1 to 3, the positive electrode terminal 30 and the negative electrode terminal 40 are attached to the sealing plate 14. In this embodiment, the positive electrode terminal 30 is arranged at one end of the sealing plate 14 in the longitudinal direction Y (the left end in FIGS. 1 to 3). In this embodiment, the negative electrode terminal 40 is arranged at the other end of the sealing plate 14 in the longitudinal direction Y (the right end in FIGS. 1 to 3).

The positive electrode terminal 30 is, as shown in FIG. 2, electrically connected to the positive electrode 22 of the electrode assembly 20 through the positive electrode current collector 50 inside the exterior body 12 (see FIG. 5). In the inside of the exterior body 12, a part of the positive electrode terminal 30 is joined to the positive electrode current collector 50. A part of the positive electrode terminal 30 is inserted in the through hole 51h in the first current-collecting member 51 of the positive electrode current collector 50 and is crimped to the edge of the through hole 51h. The positive electrode terminal 30 is inserted into the terminal mounting hole 18 and is drawn out from the inside of the sealing plate 14 to the outside. The positive electrode terminal 30 is insulated from the sealing plate 14 by a first insulating member 71 and a second insulating member 72. The positive electrode terminal 30 is preferably made of, for example, aluminum or an aluminum alloy. An external conductive member 35 is fixed on the positive electrode terminal 30. The positive electrode terminal 30 is joined to the external conductive member 35 (made of aluminum or an aluminum alloy).

The negative electrode terminal 40 is, as shown in FIG. 2, electrically connected to the negative electrode 24 of the electrode assembly 20 through the negative electrode current collector 60 inside the exterior body 12 (see FIG. 5). In the inside of the exterior body 12, a part of the negative electrode terminal 40 is joined to the negative electrode current collector 60. A part of the negative electrode terminal 40 is inserted in the through hole 61h in the first current-collecting member 61 of the negative electrode current collector 60 and is crimped to the edge of the through hole 61h. The negative electrode terminal 40 is inserted into the terminal mounting hole 19 and is drawn out from the inside of the sealing plate 14 to the outside. The negative electrode terminal 40 is insulated from the sealing plate 14 by a first insulating member 71 and a second insulating member 72. The negative electrode terminal 40 is preferably made of, for example, copper or a copper alloy. An external conductive member 45 (made of copper or a copper alloy) is fixed on the negative electrode terminal 40. The negative electrode terminal 40 is joined to the external conductive member 45.

The positive electrode current collector 50, as shown in FIG. 2, electrically connects the positive electrode 22 and the positive electrode terminal 30 of the electrode assembly 20 inside the exterior body 12 (see FIG. 5). In this embodiment, a part of the positive electrode current collector 50 is connected to the positive electrode terminal 30. The other portion of the positive electrode current collector 50 is connected to the positive electrode tab group 23 of the electrode assembly 20. The positive electrode current collector 50 is preferably made of, for example, aluminum or an aluminum alloy.

As shown in FIG. 2, the positive electrode current collector 50 includes a first current-collecting member 51 and a second current-collecting member 52. In this embodiment, the first current-collecting member 51 has an L-shaped cross-section and includes a first plate section 511 and a second plate section 512. The first plate section 511 herein has a plate shape and extends from the second plate section 512 towards the bottom wall 12a of the exterior body 12. The first plate section 511 is connected to the second current-collecting member 52. The second plate section 512 herein has a plate shape. As shown in FIG. 2, the second plate section 512 is arranged along the inner surface of the sealing plate 14. The second plate section 512 is connected to the first plate section 511 at the end on the second side wall 12c (see FIG. 1) side.

As shown in FIGS. 2 to 4, the second current-collecting member 52 extends toward the bottom wall 12a of the exterior body 12. The second current-collecting member 52 includes a first connection part 52a and a second connection part 52b. The first connection part 52a is electrically connected to the first current-collecting member 51. In this embodiment, the first connection part 52a is connected to the first current-collecting member 51 through the connection part 521. The first connection part 52a extends along the vertical direction Z. In this embodiment, the first connection part 52a is arranged approximately perpendicular to the winding axis WL of each electrode assembly 20.

As shown in FIGS. 3 and 4, a fuse 52f is formed in the first connection part 52a. The first connection part 52a is configured such that the fuse 52f is melted when a current (e.g., short circuit current) of 1000 A or more flows in the energy storage device 1. The fuse 52f has a cross-sectional area smaller than the area of the first connection part 52a excluding the fuse 52f and the connection part 521. The fuse 52f is, for example, an opening or a thin wall part. The first connection part 52a includes the fuse 52f and thereby configured so as to melt when a current as mentioned above flows.

The second connection part 52b is joined to the positive electrode tab group 23. In this embodiment, the second connection part 52b extends along the vertical direction Z. The second connection part 52b is arranged approximately perpendicular to the winding axis WL of each electrode assembly 20. The surface of the second connection part 52b connected to the positive electrode tabs 22t is arranged approximately parallel to the second side wall 12c of the exterior body 12.

The negative electrode current collector 60, as shown in FIG. 2, electrically connects the negative electrode 24 and the negative electrode terminal 40 of the electrode assembly 20 inside the exterior body 12 (see FIG. 5). In this embodiment, a part of the negative electrode current collector 60 is connected to the negative electrode terminal 40. The other portion of the negative electrode current collector 60 is connected to the negative electrode tab group 25 of the electrode assembly 20. The negative electrode current collector 60 is preferably made of, for example, copper or a copper alloy. The structure, connection with the negative electrode tab group 25, and so on of the negative electrode current collector 60 may be the same as the structure, connection with the positive electrode current collector 50 and the positive electrode tab group 23, and so on of the positive electrode current collector 50. Accordingly, the explanation here is omitted. In FIG. 4, the reference numeral “621” indicates a connection part, the reference numeral “62a” indicates a first connection part, the reference numeral “62b” indicates a second connection part, and the reference numeral “62f” indicates a fuse.

The various insulating members include, for example, the electrode assembly holder 29, first insulating member 71, second insulating member 72, and third insulating member 73 (see FIG. 2). As shown in FIG. 2, the first insulating member 71 is arranged between the positive electrode current collector 50 and the sealing plate 14 and between the negative electrode current collector 60 and the sealing plate 14. The first insulating member 71 may include a portion for insulating, for example, between the electrode assembly 20 and the sealing plate 14 (see FIG. 2). The second insulating member 72 is arranged between the positive electrode terminal 30 and the sealing plate 14 and between the negative electrode terminal 40 and the sealing plate 14. The third insulating member 73 is arranged between the external conductive member 35 and the sealing plate 14 and between the external conductive member 45 and the sealing plate 14. The constituent materials of the first insulating member 71, second insulating member 72, and third insulating member 73 may be, for example, the same as the constituent materials of the insulating members that are used in the same purpose in this type of energy storage devices.

As the nonaqueous electrolyte, nonaqueous electrolytes that are used as the electrolytes of this type of energy storage devices can be used without any limitation.

The energy storage device 1 can be used in various purposes, for example, can be preferably used as a power source (drive power supply) for a motor mounted on a vehicle such as a passenger car and a truck. The type of the vehicle is not particularly limited, but examples thereof include a plug-in hybrid vehicle (PHEV), a hybrid vehicle (HEV), and an electric vehicle (BEV). The energy storage device 1 may also be used as, for example, a single cell included in an energy storage module.

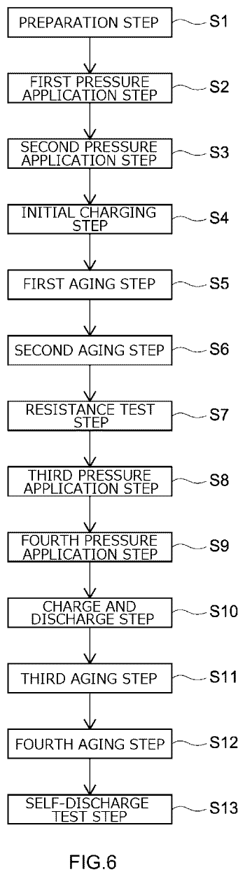

FIG. 6 is a flow diagram of a manufacturing method. As shown in FIG. 6, the manufacturing method includes a preparation step S1, a first pressure application step S2, a second pressure application step S3, an initial charging step S4, a first aging step S5, a second aging step S6, a resistance test step S7, a third pressure application step S8, a fourth pressure application step S9, a charge and discharge step S10, a third aging step S11, a fourth aging step S12, and a self-discharge test step S13. The manufacturing method will now be described with reference to the drawings as appropriate.

In the preparation step S1, an assembly in which an electrode assembly 20 and a nonaqueous electrolyte are accommodated in a case 10 is prepared. In this embodiment, in the preparation step S1, first, a first construct is prepared. The first construct includes, for example, a sealing plate 14, a positive electrode terminal 30, a negative electrode terminal 40, external conductive members 35, 45, a positive electrode current collector 50, a negative electrode current collector 60, a first insulating member 71, a second insulating member 72, and a third insulating member 73. The procedure for preparing the first construct is not particularly limited and may be the same as before.

Second, a second construct is prepared. The second construct includes, for example, the first construct and an electrode assembly 20. In the preparation of the second construct, for example, the positive electrode tab group 23 and the negative electrode tab group 25 of an electrode assembly 20 prepared by a known method are joined to current collectors with the same polarity, respectively. Examples of the joining means in the preparation step include laser welding, ultrasonic welding, and resistance welding.

Subsequently, a third construct is prepared. The third construct includes, for example, the second construct, an electrode assembly holder 29, and an exterior body 12. In the preparation of the third construct, the electrode assembly 20 of the second construct is accommodated in the electrode assembly holder 29. Subsequently, the electrode assembly holder 29 accommodating the electrode assembly 20 is accommodated in the exterior body 12. A sealing plate 14 is stacked on and joined to the opening 12h of the exterior body 12. It is not particularly limited, but the third construct may be subjected to drying treatment as needed. The conditions of the drying treatment are not particularly limited and can be appropriately set depending on the amount of moisture in the third construct and the type and so on of the resin included in the third construct.

Subsequently, a nonaqueous electrolyte is injected into the third construct. Here, the nonaqueous electrolyte is injected into the case 10 through the injection hole 15 provided in the sealing plate 14. The injection may be carried out in an atmospheric pressure or reduced pressure atmosphere. It is not particularly limited, but the pressure in the case 10 may be reduced or increased after the injection of the nonaqueous electrolyte, as needed. Subsequently, the injection hole 15 is sealed.

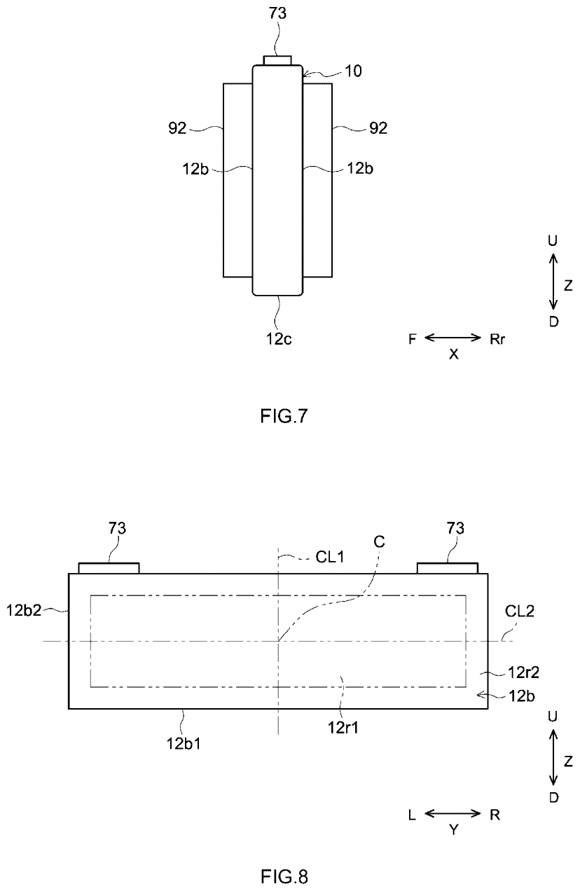

FIGS. 7 and 8 are schematic views of explaining of application of a pressure to the case 10. FIG. 7 shows a schematic side view of the case 10 applied with a pressure viewed from the second side wall 12c side. FIG. 8 shows a schematic side view of the case 10 applied with a pressure viewed from the first side wall 12b side. In the first pressure application step S2, a pressure P1 is applied to the assembly. In this embodiment, a pressure P1 is applied to the first side wall 12b of the case 10. In the mode shown in FIG. 7, a pair of the first side walls 12b in the case 10 is sandwiched between a pair of restraining jigs 92 and is applied with a pressure P1. The pair of restraining jigs 92 may be, for example, a pair of restraining plates. In such a case, a pair of restraining plates are bridged to each other with a bridging member, and a pressure P1 can be applied to the case 10.

As shown in FIG. 8, in the first pressure application step S2, restraining jigs 92 are preferably overlapped with the central region 12r1 of the first side wall 12b. The central region 12r1 herein is a region including the center C of the first side wall 12b. The center C is the intersection point of the center line CL1 of the long side 12b1 of the first side wall 12b and the center line CL2 of the short side 12b2 of the first side wall 12b. When the area of the first side wall 12 b is defined as 100%, the area of the central region 12r1 is, for example, 40% or more, preferably 50% or more, and more preferably 60% or more and about 90% or less and may be 80% or less. The restraining jigs 92 need not be arranged in the end region 12r2 presenting in the circumference of the central region 12r1 of the first side wall 12b.

The pressure P1 herein is a pressure with a magnitude that is sufficient for pushing the air bubbles and the nonaqueous electrolyte in the electrode assembly 20 to the outside of the electrode assembly 20 and for crushing the space between the positive and negative electrodes. The pressure P1 can be appropriately set but is, for example, 25 kN or more, preferably 30 kN or more, more preferably 35 kN or more, and further preferably 40 kN or more from the viewpoint of achieving the effect of the technology disclosed here. From the viewpoint of not damaging the case 10, the viewpoint of maintaining a nonaqueous electrolyte in the electrode assembly 20 to an extent that appropriate charging is possible, and other viewpoints, the pressure P1 is, for example, 100 kN or less, preferably 90 kN or less, more preferably 80 kN or less, and further preferably 70 kN or less.

The period of time for applying the pressure P1 is not particularly limited but is, for example, 1 second or more, preferably 2 seconds or more, more preferably 3 seconds or more, and further preferably 5 seconds or more from the viewpoint of achieving the effect of the technology disclosed here. The period of time for applying the pressure P1 is, for example, 60 seconds or less, preferably 50 seconds or less, more preferably 40 seconds or less, and further preferably 30 seconds or less from the viewpoint of improving the productivity of the energy storage device 1.

In the second pressure application step S3, a pressure P2 is applied to the assembly. In this embodiment, the pressure P2 is applied to the first side wall 12b of the case 10. In the second pressure application step S3, as in the first pressure application step S2, the pressure P2 may be applied to the central region 12r1 of the first side wall 12b by the restraining jigs 92 shown in FIG. 7. In this embodiment, the first pressure application step S2 and the second pressure application step S3 are consecutive. Accordingly, the state in which the restraining jigs 92 are attached to the case 10 can be maintained from the first pressure application step S2.

The pressure P2 is lower than the pressure P1. The pressure P2 here is a pressure with a magnitude that allows generation of a space between the positive and negative electrodes and infiltration of the nonaqueous electrolyte into the electrode assembly 20. The magnitude of the pressure P2 is not particularly limited as long as the effect of the technology disclosed here is achieved. From the viewpoint of achieving an appropriate distance between both electrodes during charging or discharging the assembly, the pressure P2 is preferably a tenth or more, more preferably an eighth or more, of the pressure P1. From the same viewpoint, the pressure P2 is preferably a half or less of the pressure P1. The pressure P2 is preferably 3 kN or more and less than 25 kN and more preferably 5 kN to 23 kN.

Here, the application of the pressure P2 to the assembly is maintained while the initial charging step S4, the first aging step S5, and the second aging step S6 described later are carried out. Accordingly, the period of time for applying the pressure P2 is not particularly limited.

In the initial charging step S4, the assembly is initially charged. The initial charging in this embodiment is the charging of the assembly that is the first charging after the preparation of the assembly. For example, a coat (SEI coat) can be formed on the surface of the negative electrode active material layer 24a by carrying out the initial charging step S4. Such a coat here can contain decomposition products of the nonaqueous electrolyte, additive, and so on decomposed by contact with the negative electrode active material (e.g., a carbon material such as graphite; and silicon (Si)) in the negative electrode active material layer 24a.

In the initial charging in the initial charging step S4, for example, constant-current charge is carried out at a predetermined current value until the charge depth (state of charge: SOC) of the assembly reaches a desired value. The SOC of the assembly after the initial charging is, for example, 5% to 50%, preferably 10% to 40%, and more preferably 20% to 30%. The current value during the initial charging is, for example, 0.05 C to 5 C and preferably 0.1 C to 3 C. The temperature conditions during the initial charging in the initial charging step S4 are, for example, 10° C. to 40° C. and preferably 20° C. to 30° C.

In the first aging step S5, the assembly after the initial charging step S4 is maintained in a predetermined temperature range. In this embodiment, the temperature range for maintaining the assembly in the first aging step S5 is, for example, 40° C. to 80° C., preferably 50° C. to 70° C. and more preferably 55° C. to 65° C. The maintaining time of the assembly is, for example, 6 to 72 hours, preferably 12 to 48 hours, and more preferably 18 to 24 hours.

In the second aging step S6, for example, the assembly after the first aging step S5 is maintained in a temperature range lower than the temperature range in the first aging step S5. In this embodiment, the temperature range for maintaining the assembly in the second aging step S6 is, for example, 10° C. or higher and less than 40° C., preferably 15° C. to 35° C., and more preferably 20° C. to 30° C. The maintaining time of the assembly is, for example, 6 to 72 hours, preferably 12 to 48 hours, and more preferably 18 to 24 hours.

In the resistance test step S7, the internal resistance of the assembly after the second aging step S6 is calculated. In this embodiment, the resistance test step S7 is preferably carried out in the temperature range of the second aging step S6. In the calculation of the internal resistance of the assembly in the resistance test step S7, the assembly is discharged at a discharge current of 100 A (0.5 C) for 10 seconds, and the internal resistance is calculated using the voltages before and after the discharge, V1 and V2, respectively and the discharge current A by the following equation (1):

$$Internal resistance = ( V 1 - V 2 ) / A . \qquad ( 1 )$$

In the resistance test step S7, it is not particularly limited, for example, a charge and discharge device, such as a lithium ion battery charge and discharge cycle test system manufactured by IEM Co., Ltd., may be used. The timing of carrying out the resistance test step S7 does not necessarily have to be as shown in FIG. 6 and can be set as appropriate.

In the third pressure application step S8, a pressure P3 is applied to the assembly. In this embodiment, the pressure P3 is applied to the assembly after the resistance test step S7. Here, the pressure P3 is applied to the first side wall 12b of the case 10. In the third pressure application step S8, the pressure P3 may be applied to the central region 12r1 of the first side wall 12b by the restraining jigs 92 shown in FIG. 7 as in the first pressure application step S2 and the second pressure application step S3.

The pressure P3 can be set as appropriate but is, for example, 25 kN or more, preferably 30 kN or more, more preferably 35 kN or more, and further preferably 40 kN or more from the viewpoint of achieving the effect of the technology disclosed here. From the viewpoint of not damaging the case 10, the viewpoint of maintaining a nonaqueous electrolyte in the electrode assembly 20 to an extent that appropriate charging is possible, and other viewpoints, the pressure P3 is, for example, 100 kN or less, preferably 90 kN or less, more preferably 80 kN or less, and further preferably 70 kN or less. The magnitude of the pressure P3 may be the same as or different from the magnitude of the pressure P1. Accordingly, in the third pressure application step S8, the pressure P1 may be applied to the assembly.

The period of time for applying the pressure P3 is not particularly limited but is, for example, 0.5 seconds or more, preferably 1 second or more, more preferably 2 seconds or more, further preferably 3 seconds or more, and particularly preferably 5 seconds or more from the viewpoint of achieving the effect of the technology disclosed here. The period of time for applying the pressure P3 is, for example, 60 seconds or less, preferably 50 seconds or less, more preferably 40 seconds or less, and further preferably 30 seconds or less from the viewpoint of improving the productivity of the energy storage device 1.

In the fourth pressure application step S9, a pressure P4 is applied to the assembly after the third pressure application step S8. In this embodiment, the pressure P4 is applied to the first side wall 12b of the case 10. In the fourth pressure application step S9, as in the first pressure application step S2, the second pressure application step S3, and the third pressure application step S8, the pressure P4 may be applied to the central region 12r1 of the first side wall 12b by the restraining jigs 92 shown in FIG. 7. In this embodiment, the third pressure application step S8 and the fourth pressure application step S9 are consecutive. Accordingly, the state in which the restraining jigs 92 are attached to the case 10 can be maintained from the third pressure application step S8.

The pressure P4 is lower than the pressure P3. The magnitude of the pressure P4 is not particularly limited as long as the effect of the technology disclosed here is achieved. From the viewpoint of achieving an appropriate distance between both electrodes during charging or discharging the assembly, the pressure P4 is preferably a tenth or more, more preferably an eighth or more, of the pressure P3. From the same viewpoint, the pressure P4 is preferably a half or less of the pressure P3. The pressure P4 is preferably 3 kN or more and less than 25 kN and more preferably 5 kN to 23 kN. The magnitude of the pressure P4 may be the same as or different from the magnitude of the pressure P2. Accordingly, in the fourth pressure application step S9, the pressure P2 may be applied to the assembly.

Here, the application of the pressure P4 to the assembly is maintained while the charge and discharge step S10, the third aging step S11, and the fourth aging step S12 described later are carried out. Accordingly, the period of time for applying the pressure P4 is not particularly limited.

In the charge and discharge step S10, the assembly is charged and discharged. In the charge and discharge step S10, for example, the assembly is charged until the SOC reaches 100%. When the SOC of the assembly reaches 100%, the assembly is discharged until the SOC reaches 25%. The temperature conditions in the charge and discharge step S10 may be the same as the temperature conditions in the initial charging step S4. The current values at the time of charge and discharge in the charge and discharge step S10 are not particularly limited and can be set as appropriate.

In the third aging step S11, the assembly after the charge and discharge step S10 is maintained in a predetermined temperature range. Various conditions such as temperature conditions and time conditions in the third aging step S11 can be set as appropriate while reference to the conditions described in the first aging step S5.

In the fourth aging step S12, the assembly after the third aging step S11 is maintained in a temperature range lower than the temperature range of the third aging step S11. Various conditions such as temperature conditions and time conditions in the fourth aging step S12 can be set as appropriate while reference to the conditions described in the second aging step S6.

In the self-discharge test step S13, the assembly after the fourth aging step S12 is left to stand for a predetermined test period at a predetermined test temperature to cause self-discharge, and the degree of the self-discharge is inspected. The self-discharge is judged by the value obtained by dividing the difference between the voltage V3 tested after 50 hours or more from the completion of the third aging step S11 and the voltage V4 tested after 108 hours or more from the measurement of V3 by the time elapsed between V3 and V4. For example, an assembly of which the self-discharge obtained in the test is within a predetermined range may be defined as an accepted product (good product), and an assembly of which the self-discharge is not within the range may be defined as a rejected product (defective product). The test temperature may be appropriately set, for example, within a range of 20° C. to 30° C.

In this embodiment, an energy storage device 1 can be manufactured by carrying out the steps. The manufacturing process described above is an example, and a part of the steps may be appropriately omitted, or a step included in the manufacturing of this type of energy storage device may be added.

The manufacturing method described above is a method for manufacturing an energy storage device 1 including an electrode assembly 20, a nonaqueous electrolyte, and a case 10 accommodating the electrode assembly 20 and the nonaqueous electrolyte. This manufacturing method includes preparing an assembly in which an electrode assembly 20 and a nonaqueous electrolyte are accommodated in a case 10 (preparation step S1), applying a pressure P1 to the assembly (first pressure application step S2), applying a pressure P2 lower than the pressure P1 to the assembly after the application of the pressure P1 (second pressure application step S3), and charging the assembly while applying the pressure P2 to the assembly (initial charging step S4).

In other words, in the manufacturing method, a pressure P1 higher than a pressure P2 is applied to the assembly before charging while restraining the assembly with a pressure P2. The gap in the electrode assembly 20 can be crushed by applying the pressure P1 to the assembly. By this, air bubbles remaining in the electrode assembly 20 can be forced out from the electrode assembly 20. Consequently, air bubbles can be prevented from remaining in the electrode assembly 20 during charging. Accordingly, occurrence of uneven charging in the electrode assembly 20 can be suppressed. Furthermore, since air bubbles are sufficiently discharged from the electrode assembly 20 to the outside of the electrode assembly 20 during the period of application of the pressure P1, air bubbles are hardly discharged to the outside of the electrode assembly from the electrode assembly 20 during the period of application of the pressure P2. Consequently, an appropriate state of restraining the electrode assembly 20 can be maintained during the period of applying the pressure P2.

The application of the pressure P1 to the assembly and the application of the pressure P2 to the assembly may be carried out continuously. By this, it is possible to avoid occurrence of the state in which no pressure is applied to the assembly between application of the pressure P1 and application of the pressure P2. Consequently, it is possible to restrict the amount of the nonaqueous electrolyte that infiltrates into the electrode assembly between application of the pressure P1 and application of pressure P2. By this, the nonaqueous electrolyte is pushed out from the electrode assembly 20 during the period of application of the pressure P2 to the assembly to more appropriately suppress the decrease in the pressure that is applied to the electrode assembly 20, and it is possible to maintain an appropriate state of restraining the electrode assembly 20. In addition to this, it is possible to suppress the gas discharged from the electrode assembly 20 from returning to the electrode assembly 20 between the application of the pressure P1 and the application of the pressure P2. Consequently, the effect of the technology disclosed here can be more appropriately achieved.

The charging may be initial charging. If initial charging is performed with air bubbles remaining in the electrode assembly 20, uneven initial charging occurs in the electrode assembly 20, and a larger decrease in the battery performance of the energy storage device 1 may be caused. Accordingly, the effect of the technology disclosed here can be more appropriately achieved by carrying out initial charging while applying the pressure P2 to the assembly after applying the pressure P1 to the assembly, and the battery performance of the energy storage device 1 can be more appropriately achieved.

The pressure P2 may be from a tenth to a half of the pressure P1. In other words, the pressure P1 may be twice to 10 times the pressure P2. By setting the ratio of the pressure P1 and the pressure P2 within such a range, the effect of the technology disclosed here can be suitably achieved.

The period of application of the pressure P1 may be from 1 second to 60 seconds. By this, the effect of the technology disclosed here can be suitably achieved, and the time required for manufacturing the energy storage device 1 is suppressed from becoming too long.

The electrode assembly 20 may be a flat wound electrode assembly in which a long sheet-like positive electrode 22 and a long sheet-like negative electrode 24 are stacked with a separator 26 therebetween and are wound in the sheet longitudinal direction. In the electrode assembly 20, which is a wound electrode assembly, the internal discharge ports for air bubbles are limited to two open faces (first open face 20a1 and second open face 20a2). Consequently, air bubbles tend to remain inside the electrode assembly 20. Consequently, the effect of the technology disclosed here can be further preferably achieved in the electrode assembly 20, which is a wound electrode assembly.

Due to the increasing demand for higher capacity and so on in recent years, it is expected that the width of the body 20a of the electrode assembly 20 in the energy storage device 1 is increased. Accordingly, the width of the body 20a of the electrode assembly 20 may be appropriately set within the range. By this, a higher capacity of the energy storage device 1 is achieved, the effect of the technology disclosed here is more appropriately achieved, and higher battery performance can be achieved. The wider the body 20a of the electrode assembly 20, the more likely gas will remain inside the electrode assembly 20. Accordingly, the effect of the technology disclosed here can be more preferably achieved as the width of the body 20a of the electrode assembly 20 increases.

The case 10 may include a rectangular bottom wall 12a and a pair of opposing first side walls extending from a pair of opposing long sides 12b of the bottom wall 12a. The electrode assembly 20 may include a rectangular surface 20a3 at each end of the positive electrode 22 and the negative electrode 24 in the stacking direction. The rectangular surface 20a3 may oppose the first side wall 12b. The pressure P1 and the pressure P2 may be added to the first side wall 12b. Application of the pressure P1 and the pressure P2 to the first side wall 12b can apply the pressures to the rectangular surface 20a3 of the electrode assembly 20. By this, air bubbles can be more efficiently discharged from the inside of the electrode assembly 20.

The manufacturing method may further include applying a pressure P3 to the assembly after discharging (third pressure application step S8), applying a pressure P4 lower than the pressure P3 to the assembly after the application of the pressure P3 (fourth pressure application step S9), and charging the assembly while applying the pressure P4 (charge and discharge step S10). By this, air bubbles that are generated in the electrode assembly 20 by carrying out other steps (e.g., first aging step S5 and second aging step S6) for the assembly after charging can be efficiently discharged to the outside of the electrode assembly 20.

Embodiments of the technology disclosed here have been described above, but are merely examples, and do not limit the scope of the present invention. The technology described in claims includes various transformations and modifications of the embodiments.

For example, in the embodiments, the manufacturing method includes both a set of the first pressure application step S2 and the second pressure application step S3 and a set of the third pressure application step S8 and the fourth pressure application step S9. However, the technology disclosed here is not limited thereto, and the manufacturing method has only to include at least one of the set of the first pressure application step S2 and the second pressure application step S3 and the set of the third pressure application step S8 and the fourth pressure application step S9. The manufacturing method may include only the set of the first pressure application step S2 and the second pressure application step S3 and need not include the set of the third pressure application step S8 and the fourth pressure application step S9. Alternatively, the manufacturing method may include only the set of the third pressure application step S8 and the fourth pressure application step S9 and need not include the set of the first pressure application step S2 and the second pressure application step S3.

Test examples relating to the technology disclosed here will be described below, but it is not intended that the technology disclosed here be limited to the following test examples. For the reference numerals used in the description of the test examples, refer to the reference numerals shown in the drawings as appropriate.

Test cells as an object of this test example were prepared. The test cells included three electrode assemblies 20 being wound electrode assemblies as shown in FIGS. 4 and 5, a nonaqueous electrolyte, and a square case 10 accommodating the three electrode assemblies 20 and the nonaqueous electrolyte (see FIG. 3). Regarding the size of each electrode assembly 20, the width (the length of the long side of the rectangular surface 20a3) of the body 20a was 292 mm. The height (the length of the short side of the rectangular surface 20a3) of the body 20a was 95 mm. The thickness (the distance between the rectangular surfaces 20a3) of the body 20a was 12 mm. Regarding the dimensions of the case 10, the length of the long side 12b1 of the first side wall 12b was 308 mm. The length of the short side 12b2 of the first side wall 12b was 103 mm. The thickness (distance between the first side walls 2b) of the case 10 was 40 mm.

### EXAMPLE

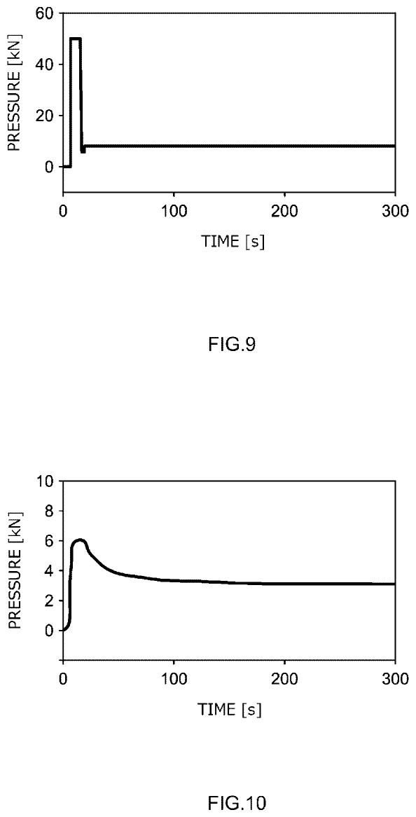

One of the test cells was sandwiched between a pair of SUS plates, and a load was applied in the thickness direction of the test cell using autograph. In this example, a load was applied to the central region 12r1 with a size of 290 mm×77 mm in the first side wall 12b. In this example, first, a load of 49 kN was applied to the test cell for 8 seconds. Second, the load was released, and a load of 6.0 kN was applied to the test cell for 2 seconds. Subsequently, a load of 8.2 kN was applied to the test cell for 300 seconds. During the period of applying the load to the test cell, the thickness of the test cell was measured using a laser displacement gauge. Based on the amount of change in the thickness of the test cell during the period, the pressure applied to the test cell during the period of applying a load of 8.2 kN to the test cell was calculated. Based on this pressure, the degree of load release during the period was calculated. The results are shown in FIG. 9. FIG. 9 is a graph showing changes in pressure applied to the test cell over time in Example. In FIG. 9, the X-axis indicates the load application time(s) (the same is applied also to FIG. 10). The Y-axis indicates the pressure (kN) applied to the test cell (the same is applied also to FIG. 10). The autograph used in the test example was a universal testing instrument (autograph AGX-V) manufactured by Shimadzu Corporation. The laser displacement gauge used in the test example was LK-G157 manufactured by Keyence Corporation.

### Comparative Example

In this example, application of a load of 6.0 kN was carried out for 7 seconds to another of the test cells, instead of the application of a load 49 kN and application of a load of 6.0 kN in Example. Subsequently, a load of 6.0 kN was applied to the test cell for 300 seconds. Except the above, the pressure applied to the test cell during the period of applying a load of 6.0 kN for 300 seconds was calculated using the same apparatus and procedure as those in Example, and the degree of load release during the period was further calculated. The results are shown in FIG. 10. FIG. 10 is a graph showing changes in pressure applied to the test cell over time in Comparative Example.

Results

In Example, in the period of applying a load of 8.2 kN for 300 seconds, the pressure applied to the test cell was decreased from 8.2 kN to 8.0 kN. That is, the degree of load release in Example was 2%. This demonstrates that in Example, air bubbles are suppressed from remaining in the electrode assembly 20 during the period of applying a load of 8.2 kN for 300 seconds. In contrast, in Comparative Example, the pressure applied to the test cell was decreased from 6.0 kN to 3.1 kN during the period of applying a load of 6.0 kN for 300 seconds. That is, the degree of load release in Comparative Example was 48%. It is inferred from this that in Comparative Example, air bubbles remained in the electrode assembly 20 during the period of applying a load of 6.0 kN for 300 seconds, and the air bubbles were gradually discharged to the outside of the electrode assembly 20 to cause the load release of the test cell.

The technology disclosed here can include aspects described in the following items:
Item 1:

A method for manufacturing an energy storage device comprising an electrode assembly, a nonaqueous electrolyte, and a case accommodating the electrode assembly and the nonaqueous electrolyte, the method comprising:
preparing an assembly with the case accommodating the electrode assembly and the nonaqueous electrolyte;
applying a pressure P1 to the assembly;
applying a pressure P2 lower than the pressure P1 to the assembly after the application of the pressure P1; and
charging the assembly while applying the pressure P2 to the assembly;
Item 2:

The manufacturing method according to Item 1, wherein
application of the pressure P1 to the assembly and application of the pressure P2 to the assembly are carried out continuously;
Item 3:

The manufacturing method according to Item 1 or 2, wherein
the charging is initial charging;
Item 4:

The manufacturing method according to any one of Items 1 to 3, wherein
the pressure P2 is from a tenth to a half of the pressure P1;
Item 5:

The manufacturing method according to any one of Items 1 to 4, wherein
a period of application of the pressure P1 is from 1 to 60 seconds;
Item 6:

The manufacturing method according to any one of Items 1 to 5, wherein
the electrode assembly is a flat wound electrode assembly including a long sheet-like positive electrode and a long sheet-like negative electrode stacked with a separator therebetween and wound in the sheet longitudinal direction;
Item 7:

The manufacturing method according to any one of Items 1 to 6, wherein
the case includes a rectangular bottom wall and a pair of opposing first side walls extending from a pair of opposing long sides of the bottom wall,
the electrode assembly has rectangular surfaces at both ends in the stacking direction of the positive electrode and the negative electrode,
the rectangular surfaces oppose the first side walls, and
the pressure P1 and the pressure P2 are applied to the first side walls; and
Item 8:

The manufacturing method according to any one of Items 1 to 7, further comprising:
applying a pressure P3 to the assembly after the charging;
applying a pressure P4 lower than the pressure P3 to the assembly after the application of the pressure P3; and
charging the assembly while applying the pressure P4.

What is claimed is:

1. A method for manufacturing an energy storage device comprising an electrode assembly, a nonaqueous electrolyte, and a case accommodating the electrode assembly and the nonaqueous electrolyte, the method comprising:
preparing an assembly with the case accommodating the electrode assembly and the nonaqueous electrolyte;
applying a pressure P1 to the assembly;
applying a pressure P2 lower than the pressure P1 to the assembly after the application of the pressure P1; and
charging the assembly while applying the pressure P2 to the assembly.

2. The manufacturing method according to claim 1, wherein
application of the pressure P1 to the assembly and application of the pressure P2 to the assembly are carried out continuously.

3. The manufacturing method according to claim 1, wherein
the charging is initial charging.

4. The manufacturing method according to claim 1, wherein
the pressure P2 is from a tenth to a half of the pressure P1.

5. The manufacturing method according to claim 1, wherein
a period of application of the pressure P1 is from 1 second to 60 seconds.

6. The manufacturing method according to claim 1, wherein
the electrode assembly is a wound electrode assembly which is flat and includes a long sheet-like positive electrode and a long sheet-like negative electrode stacked with a separator therebetween and wound in a sheet longitudinal direction.

7. The manufacturing method according to claim 6, wherein
the case includes a rectangular bottom wall and a pair of opposing first side walls extending from a pair of opposing long sides of the bottom wall,
the electrode assembly has rectangular surfaces at both ends in a stacking direction of the positive electrode and the negative electrode,
the rectangular surfaces oppose the first side walls, and
the pressure P1 and the pressure P2 are applied to the first side walls.

8. The manufacturing method according to claim 1, further comprising:
applying a pressure P3 to the assembly after the charging;
applying a pressure P4 lower than the pressure P3 to the assembly after the application of the pressure P3; and
charging the assembly while applying the pressure P4.
